(19) United States
(12) Patent Application Publication
(10) Pub. No.: US 2026/0180741 A1
(43) Pub. Date: Jun. 25, 2026

(54) FINITE-PRECISION ENERGY-BASED ARITHMETIC ENCODING

(71) Applicant: QUALCOMM Incorporated, San Diego, CA (US)

(72) Inventors: Wei LIU, Beijing (CN); Thomas Joseph RICHARDSON, South Orange, NJ (US); Changlong XU, Beijing (CN); Liangming WU, Beijing (CN); Ori SHENTAL, Marlboro, NJ (US); Hao XU, Beijing (CN)

(21) Appl. No.: 19/129,978

(22) PCT Filed: Feb. 3, 2023
(86) PCT No.: PCT/CN2023/074327

§ 371 Date: May 14, 2025

(51) Int. Cl. H04L 5/00; H04L 1/00

(52) U.S. Cl. CPC H04L 5/0048; H04L 1/0041; H04L 1/0068

(57) ABSTRACT

Various aspects of the present disclosure generally relate to wireless communication. In some aspects, a wireless communication device (WCD) may encode a set of bits to a sequence of symbols, the encoding using finite-precision energy-based arithmetic encoding and including iterative operations comprising: identifying one or more quantities of candidate sequences having a length of remaining symbols of the sequence after selecting a symbol of the sequence of symbols and satisfying a remaining amount of a maximum sequence energy after using the selected symbol, the one or more quantities having finite precisions; identifying interval boundaries based at least in part on partial sums of the one or more quantities; and selecting a symbol of the sequence of symbols based at least in part on the interval boundaries and an information integer to be encoded. Numerous other aspects are described.

### FIELD OF THE DISCLOSURE

Aspects of the present disclosure generally relate to wireless communication and to techniques and apparatuses for finite-precision energy-based arithmetic encoding.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device (WCD). The method may include encoding a set of bits to a sequence of symbols, members of the sequence of symbols included in a set of symbols, the encoding using finite-precision energy-based arithmetic encoding and including iterative operations comprising: identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions identifying interval boundaries based at least in part on partial sums of the one or more quantities selecting a symbol of the sequence of symbols based at least in part on the interval boundaries and an information integer to be encoded, the information integer being based at least in part on an integer representation of the set of bits. The method may include transmitting a communication that includes the sequence of symbols encoded with the finite-precision energy-based arithmetic encoding.

Some aspects described herein relate to a WCD for wireless communication. The WCD may include memory, one or more processors coupled to the memory, and instructions stored in the memory and executable by the one or more processors. The instructions may be executable by the one or more processors to cause the wireless communication device to encode a set of bits to a sequence of symbols, members of the sequence of symbols included in a set of symbols, the encoding using finite-precision energy-based arithmetic encoding and including iterative operations comprising identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions identifying interval boundaries based at least in part on partial sums of the one or more quantities selecting a symbol of the sequence of symbols based at least in part on the interval boundaries and an information integer to be encoded, the information integer being based at least in part on an integer representation of the set of bits. The instructions may be executable by the one or more processors to cause the wireless communication device to transmit a communication that includes the sequence of symbols encoded with the finite-precision energy-based arithmetic encoding.

Some aspects described herein relate to a non-transitory computer-readable medium that stores a set of instructions for wireless communication by a WCD. The set of instructions, when executed by one or more processors of the WCD, may cause the WCD to encode a set of bits to a sequence of symbols, members of the sequence of symbols included in a set of symbols, the encoding using finite-precision energy-based arithmetic encoding and including iterative operations comprising identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions identifying interval boundaries based at least in part on partial sums of the one or more quantities selecting a symbol of the sequence of symbols based at least in part on the interval boundaries and an information integer to be encoded, the information integer being based at least in part on an integer representation of the set of bits. The instructions may be executable by the one or more processors to cause the wireless communication device to transmit a communication that includes the sequence of symbols encoded with the finite-precision energy-based arithmetic encoding.

Some aspects described herein relate to an apparatus for wireless communication. The apparatus may include means for encoding a set of bits to a sequence of symbols, members of the sequence of symbols included in a set of symbols, the encoding using finite-precision energy-based arithmetic encoding and including iterative operations comprising, means for identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions means for identifying interval boundaries based at least in part on partial sums of the one or more quantities means for selecting a symbol of the sequence of symbols based at least in part on the interval boundaries and an information integer to be encoded, the information integer being based at least in part on an integer representation of the set of bits. The apparatus may include means for transmitting a communication that includes the sequence of symbols encoded with the finite-precision energy-based arithmetic encoding.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a transmit (Tx) chain and a receive (Rx) chain of a UE, in accordance with the present disclosure.

FIG. 5 is a diagram illustrating an example transmit chain for probabilistic amplitude shaping, in accordance with the present disclosure.

FIG. 6 is a diagram illustrating an example transmit chain for probabilistic amplitude shaping, in accordance with the present disclosure.

FIG. 7 is a diagram illustrating an example transmit chain for energy-based probabilistic amplitude shaping, in accordance with the present disclosure.

FIG. 8 is a diagram of an example associated with finite-precision energy-based arithmetic encoding, in accordance with the present disclosure.

FIG. 9 is a diagram illustrating an example process performed, for example, by a WCD, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

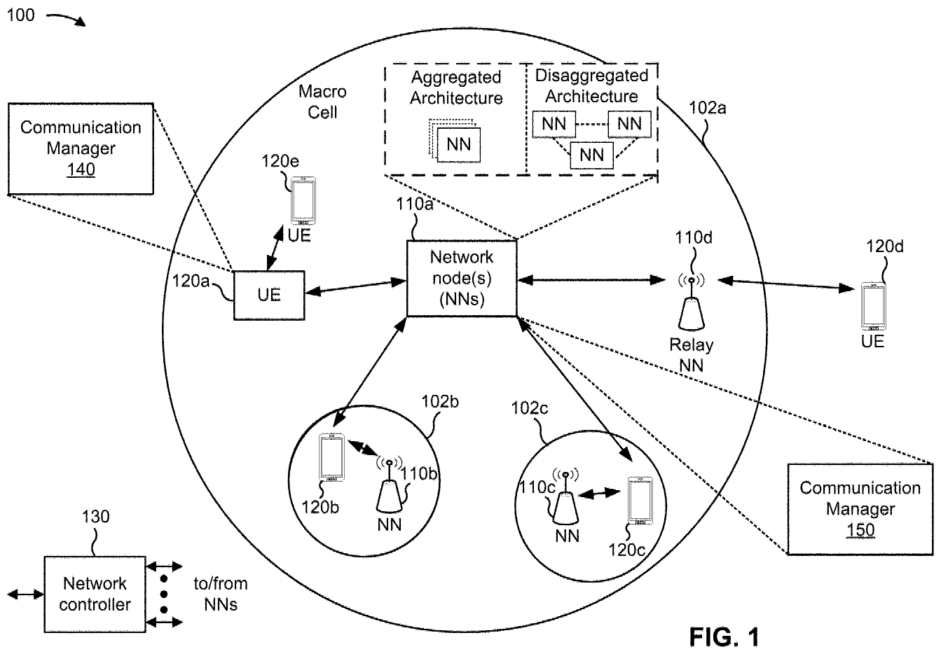

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the WCD may include a communication manager 140 or 150. As described in more detail elsewhere herein, the communication manager 140 or 150 may encode a set of bits to a sequence of symbols, members of the sequence of symbols included in a set of symbols, the encoding using finite-precision energy-based arithmetic encoding and including iterative operations comprising: identify one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identify interval boundaries based at least in part on partial sums of the one or more quantities; and select a symbol of the sequence of symbols based at least in part on the interval boundaries and an information integer to be encoded, the information integer being based at least in part on an integer representation of the set of bits; and transmit a communication that includes the sequence of symbols encoded with the finite-precision energy-based arithmetic encoding. Additionally, or alternatively, the communication manager 140 or 150 may perform one or more other operations described herein.

As indicated above, FIG. 1 is provided as an example. Other examples may differ from what is described with regard to FIG. 1.

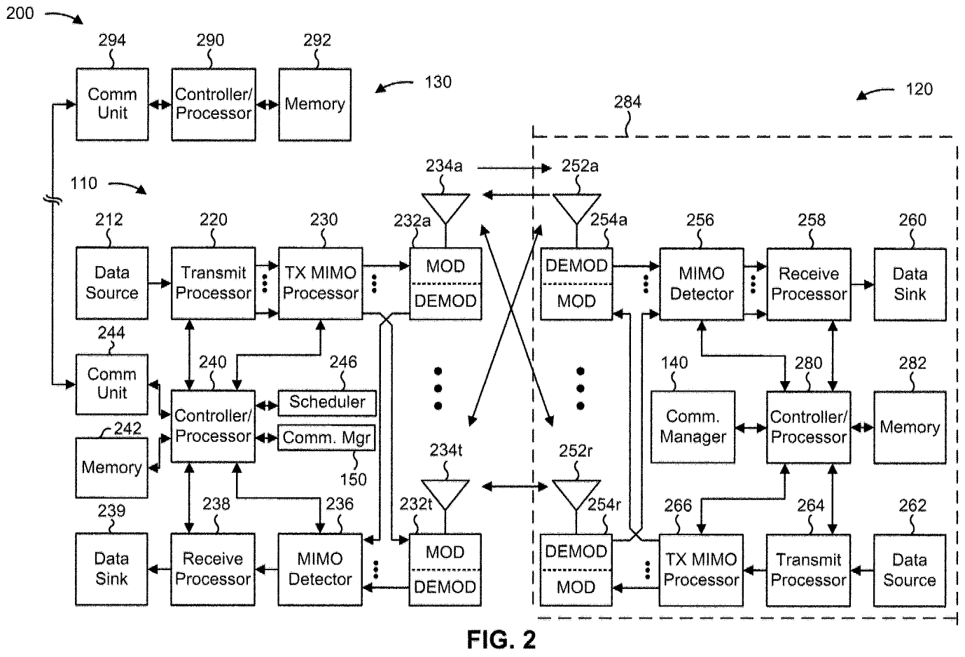

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

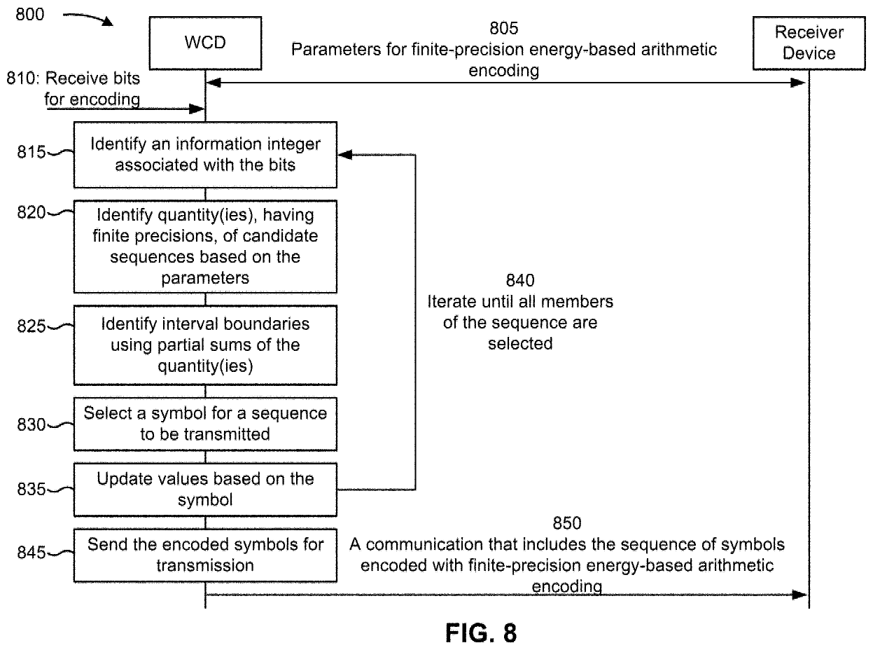

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-10).

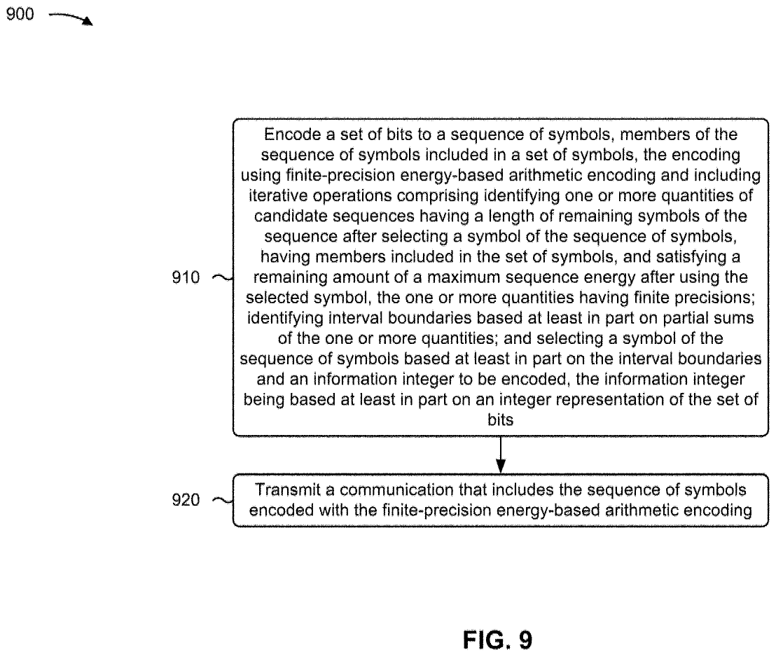

The controller/processor 240 of the network node 110, the controller/processor 280 of the UE 120, and/or any other component(s) of FIG. 2 may perform one or more techniques associated with finite-precision energy-based arithmetic encoding, as described in more detail elsewhere herein. In some aspects, the WCD described herein is the base station 110, is included in the base station 110, or includes one or more components of the base station 110 shown in FIG. 2. In some aspects, the WCD described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 900 of FIG. 9 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9 and/or other processes as described herein. In some examples, executing instructions may include running the instructions, converting the instructions, compiling the instructions, and/or interpreting the instructions, among other examples.

In some aspects, the wireless communication device (WCD) includes means for encoding a set of bits to a sequence of symbols, members of the sequence of symbols included in a set of symbols, the encoding using finite-precision energy-based arithmetic encoding and including iterative operations comprising: means for identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; means for identifying interval boundaries based at least in part on partial sums of the one or more quantities; and/or means for selecting a symbol of the sequence of symbols based at least in part on the interval boundaries and an information integer to be encoded, the information integer being based at least in part on an integer representation of the set of bits; and/or means for transmitting a communication that includes the sequence of symbols encoded with the finite-precision energy-based arithmetic encoding. In some aspects (e.g., where the WCD includes, or is included in, a network node), the means for the wireless communication device (WCD) to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects (e.g., where the WCD includes, or is included in, a UE), the means for the wireless communication device (WCD) to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

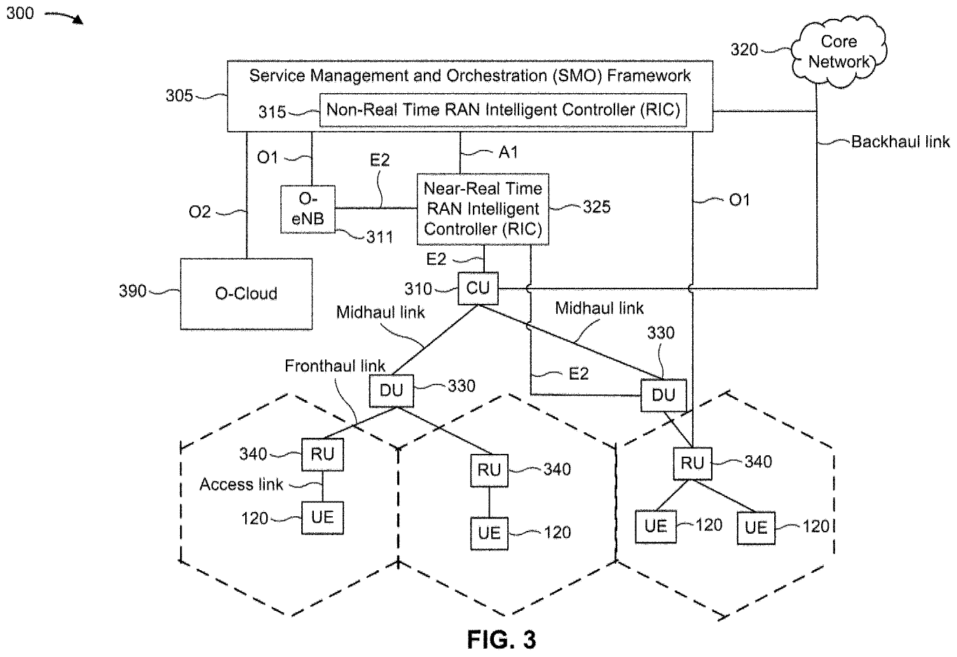

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

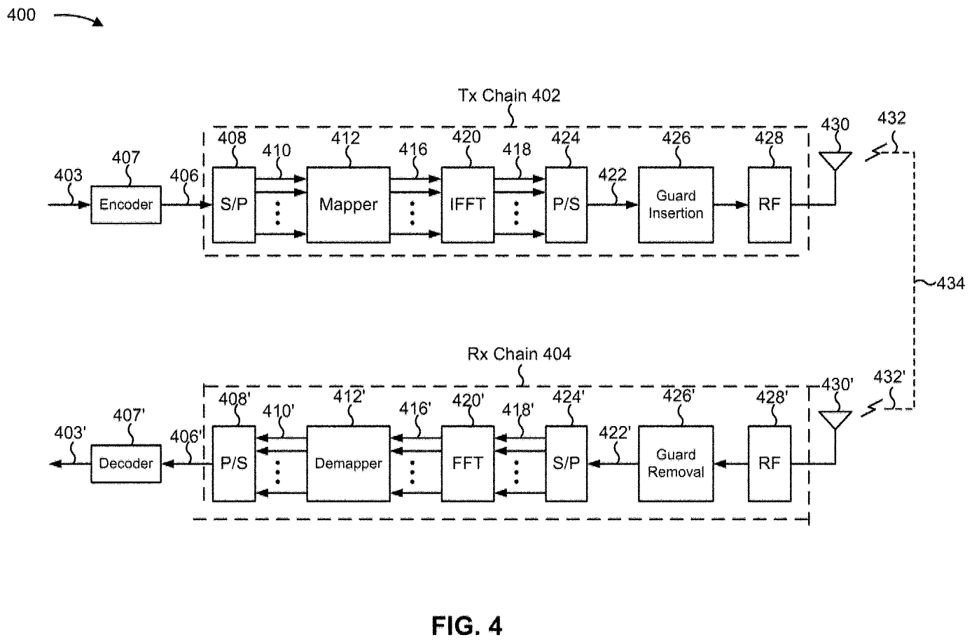

FIG. 4 is a diagram illustrating an example 400 of a transmit (Tx) chain 402 and a receive (Rx) chain 404 of a UE 120 in accordance with the present disclosure. In some examples, one or more components of Tx chain 402 may be implemented in transmit processor 264, TX MIMO processor 266, modem 254, or controller/processor 280, as described above in connection with FIG. 2. In some examples, Tx chain 402 may be implemented in UE 120 for transmitting data 406 (for example, uplink data, an uplink reference signal, or uplink control information) to a network node 110 on an uplink channel.

An encoder 407 may alter a signal (for example, a bitstream) 403 into data 406. Data 406 to be transmitted is provided from encoder 407 as input to a serial-to-parallel (S/P) converter 408. In some examples, S/P converter 408 may split the transmission data into N parallel data streams 410.

The N parallel data streams 410 may then be provided as input to a mapper 412. Mapper 412 may map the N parallel data streams 410 onto N constellation points. The mapping may be done using a modulation constellation, such as amplitude shift keying (ASK), binary phase-shift keying (BPSK), quadrature phase-shift keying (QPSK), 8 phase-shift keying (8PSK), or quadrature amplitude modulation (QAM), among other examples. Thus, mapper 412 may output N parallel symbol streams 416, each symbol stream 416 corresponding to one of N orthogonal subcarriers of an inverse fast Fourier transform (IFFT) component 420. These N parallel symbol streams 416 are represented in the frequency domain and may be converted into N parallel time domain sample streams 418 by IFFT component 420.

In some examples, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of guard insertion component 426 may then be upconverted to a desired transmit frequency band by an RF front end 428. An antenna 430 may then transmit the resulting signal 432.

In some examples, Rx chain 404 may utilize OFDM/OFDMA. In some examples, one or more components of Rx chain 404 may be implemented in receive processor 258, MIMO detector 256, modem 254, or controller/processor 280, as described above in connection with FIG. 2. In some examples, Rx chain 404 may be implemented in UE 120 for receiving data 406 (for example, downlink data, a downlink reference signal, or downlink control information) from a network node 110 on a downlink channel.

A transmitted signal 432 is shown traveling over a wireless channel 434 from Tx chain 402 to Rx chain 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by guard insertion component 426.

The output of guard removal component 426′ may be provided to an S/P converter 424′. The output may include an OFDM/OFDMA symbol stream 422′, and S/P converter 424′ may divide the OFDM/OFDMA symbol stream 422′ into N parallel time-domain symbol streams 418′, each of which corresponds to one of the N orthogonal subcarriers. A FFT component 420′ may convert the N parallel time-domain symbol streams 418′ into the frequency domain and output N parallel frequency-domain symbol streams 416′.

A demapper 412′ may perform the inverse of the symbol mapping operation that was performed by mapper 412, thereby outputting N parallel data streams 410′. A P/S converter 408′ may combine the N parallel data streams 410′ into a single data stream 406′. Ideally, data stream 406′ corresponds to data 406 that was provided as input to Tx chain 402. Data stream 406′ may be decoded into a decoded data stream 403′ by decoder 407′.

As indicated above, FIG. 4 is provided as an example. Other examples may differ from what is described with regard to FIG. 4.

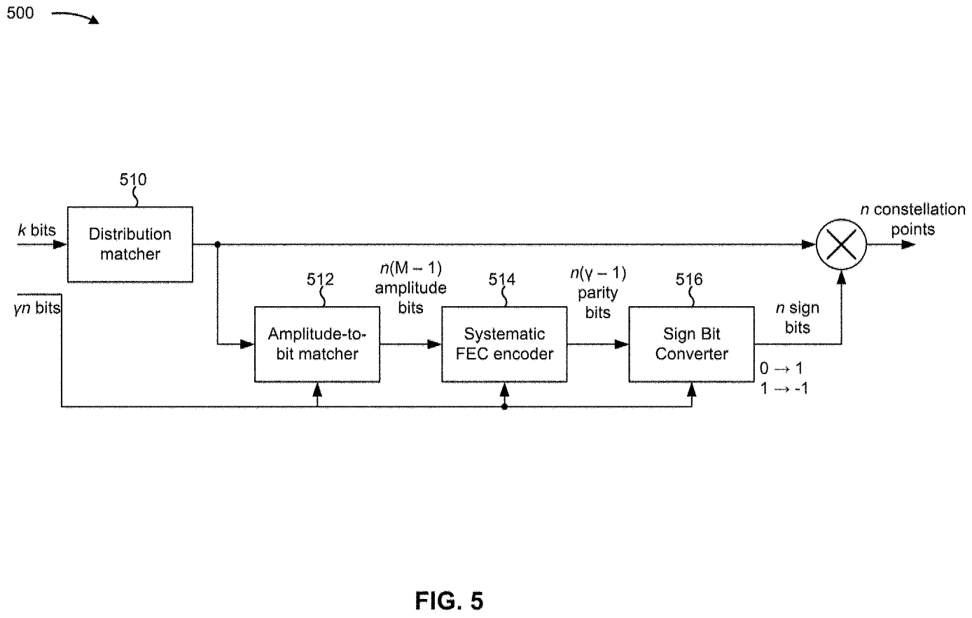

FIG. 5 is a diagram illustrating an example transmit chain 500 for probabilistic amplitude shaping in accordance with the present disclosure.

As shown in FIG. 5, the transmit chain 500 includes a distribution matcher 510, an amplitude-to-bit mapper 512, a systematic FEC encoder 514, and a sign bit converter 516. The transmit chain 500 may be used for, for example, ASK modulation with ASK constellations having a modulation order 2^{M}. An ASK constellation for the modulation order 2^{M} may include a set of constellation points (±1, ±3, . . . , ±(2^{M}−1)). In some examples, the transmit chain 500 may have a transmission rate R_{c}=R_{dm}+γ, where R_{dm} represents a rate of the distribution matcher 510 and γ represents a set of parity bits that are added the k information bits that are to be encoded.

The ASK constellations may be associated with an amplitude alphabet of text use {1, 3, . . . , (2^{M}−1)}. The amplitude alphabet can include the set of possible constellation points (for example, without sign) from which the set of constellation points is generated. For example, an amplitude alphabet [symbol] m={a₁, a₂, . . . , aₘ} of size m>1 may be configured for the transmit chain 500, with each element of [symbol] ₘ being referred to as a symbol. [symbol] ₘ may be constrained such that each element is ordered within [symbol] m (for example, a₁<a₂< . . . <aₘ for any aᵢ). A symbol may have an energy E(aᵢ) for each value of i within the alphabet [symbol] ₘ. Based on the aforementioned constraint, symbol energies are ordered in correspondence with the ordering of symbols within [symbol] ₘ, such that 0≤E(aᵢ)<E(aᵢ₊₁). For a 2^{M}-ary ASK constellation, described in FIG. 5, [symbol] ₘ={1, 3, . . . , 2^{M}−1}, where m=2^{M}−1 and {−1, 1}× [symbol] ₘ corresponds to the 2^{M}-ary constellation. In this example, aᵢ=2i−1 so that a₁=1, a₂=3, . . . , aₘ=2^{M}−1, and so that, for each i, the energy E(aᵢ)=(2i−1)² of symbol aᵢ, in a first example, or

$$E ( {a}_{i} ) = \frac{i ( i - 1 )}{2} ,$$

in a second example. In these two examples, the second example is a rescaling of the (2i−1)² term in the first example.

For the alphabet [symbol] ₘ of size m with a symbol sequence s=(s₁, s₂, . . . , sₙ) of length n, where each element of s is selected from [symbol] ₘ, the energy E(s) is an accumulation (for example, a sum) of all symbol energies of the symbol sequence

$$E ( s ) = {Σ}_{l = 1}^{n} E ( {s}_{l} ) .$$

Accordingly, for the 2^{M}-ary ASK constellation with M=3; [symbol] ₘ={1, 3, 5, 7}; and m=4, an example symbol sequence (5, 1, 1, 3, 5, 7) with length n=6 can be configured. For the example symbol sequence, symbol energies can be determined, for E(1)=1, E(3)=9, E(5)=25 and E(7)=49, such that E(s)=2E(1)+E(3)+2E(5)+E(7)=2+9+50+49=110. In another example, for E(1)=0, E(3)=1, E(5)=3 and E(7)=6, the symbol energies can be determined as E(s)=2E(1)+E(3)+2E(5)+E(7)=13.

As further shown in FIG. 5, the distribution matcher 510 may receive k information bits and map the k information bits to n amplitude symbols. The distribution matcher 510 may have a rate R_{dm}=k/n. In some examples, the distribution matcher 510 maps the information bits to the amplitude symbols to achieve a non-uniform distribution over the amplitude symbols. The non-uniform distribution induced by the distribution matcher 510 may be closer to a capacity-achieving input distribution than is achieved by a uniform distribution. In other words, the non-uniform distribution induced by the distribution matcher 510 is a probability distribution (for example, a Maxwell-Boltzmann (MB) distribution) in an additive white Gaussian noise (AWGN) channel. The transmit chain 500 may pass the n amplitude symbols to the amplitude-to-bit mapper 512, which may map the n amplitude symbols to a set of n(M−1) amplitude bits. The transmit chain 500 may pass the n(M−1) amplitude bits and γn extra information bits (for example, FEC bits) to the systematic FEC encoder 514 for FEC encoding. In this example, the systematic FEC encoder 514 receives n(M−1+γ) bits as input with a rate of R_{c}=(M−1+γ)/M. The systematic FEC encoder 514 may generate a set of n(1−γ) parity bits at the rate R_{c}. The transmit chain 500 may pass the n(1−γ) parity bits and the γn extra information bits to the sign bit converter 516, which may generate a set of n sign bits. The sign bit converter 516 generates a sign bit “1” for a bit “0” and a sign bit “−1” for a bit “1”. The transmit chain 500 may perform pointwise multiplication to combine the n amplitude symbols with the n sign bits to generate a set of n constellation points.

As indicated above, FIG. 5 is provided as an example. Other examples may differ from what is described with regard to FIG. 5.

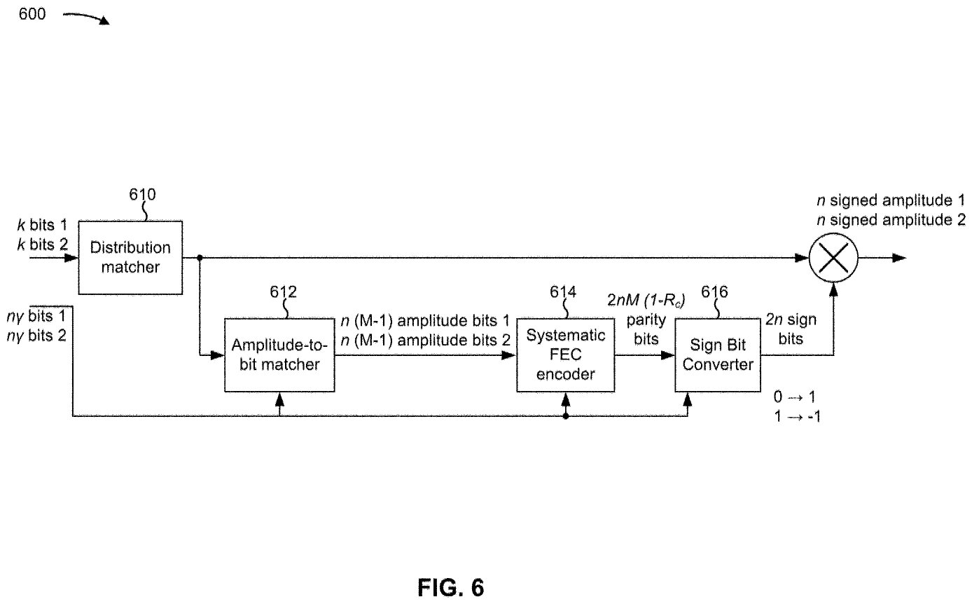

FIG. 6 is a diagram illustrating an example transmit chain 600 for probabilistic amplitude shaping in accordance with the present disclosure.

As shown in FIG. 6, the transmit chain 600 includes a distribution matcher 610, an amplitude-to-bit mapper 612, a systematic FEC encoder 614, and a sign bit converter 616. The transmit chain 600 may be used for, for example, QAM modulation with QAM constellations having a modulation order 2^{2M}. In such an example, a QAM constellation for the modulation order 2^{2M} may include a set of constellation points {±1, ±3, . . . , ±(2^{M}−1)}×{±1, ±3, . . . , ±(2^{M}−1)}.

As further shown in FIG. 6, the distribution matcher 610 may receive a first set of k information bits and a second set of k information bits and maps the sets of k information bits to corresponding sets of n amplitude symbols. The transmit chain 600 may pass the sets of n amplitude symbols to the amplitude-to-bit mapper 612, which may map the sets of n amplitude symbols to a pair of sets of n(M−1) amplitude bits. The transmit chain 600 may pass the pair of sets of n(M−1) amplitude bits and a pair of sets of γn extra information bits to the systematic FEC encoder 614 for FEC encoding. The systematic FEC encoder 614 may have an FEC codeword length of n_{c}=n log₂(2^{2M})=2 nM. In this example, the systematic FEC encoder 614 receives a total of 2└nMR_{c}┘ information bits as input in the form of two streams of n(M−1) amplitude bits from the information bits and two streams of extra information bits with each stream of extra information bits include nγ bits. The value for y may be such that nγ=└nMR_{c}┘−n(M−1). Accordingly, the total number of bits for transmission B_{T}=2(k+└nMR_{c}┘−n(M−1)). The systematic FEC encoder 614 may generate a set of 2 nM(1−R_{c}) parity bits at the rate R_{c}. The transmit chain 600 may pass the 2 nM(1−R_{c}) parity bits and the pair of sets of γn extra information bits to the sign bit converter 616, which may generate a set of 2n sign bits. The transmit chain 600 may perform pointwise multiplication to combine the sets of n amplitude symbols with the 2n sign bits to generate a pair of sets of n signed amplitudes.

As indicated above, FIG. 6 is provided as an example. Other examples may differ from what is described with regard to FIG. 6.

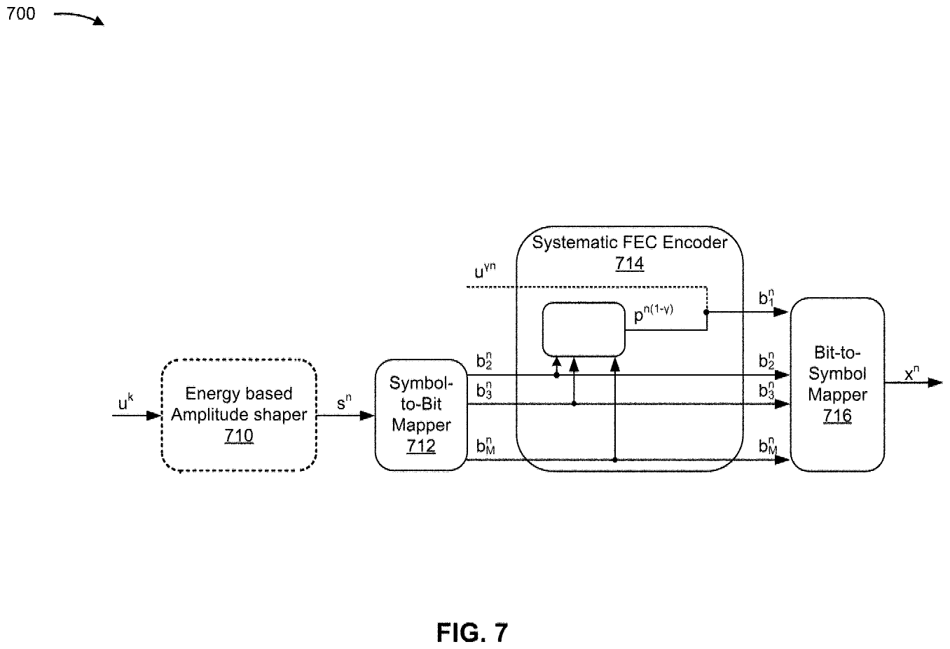

FIG. 7 is a diagram illustrating an example transmit chain 700 for energy-based probabilistic amplitude shaping in accordance with the present disclosure.

As shown in FIG. 7, the transmit chain 700 includes an energy-based amplitude shaper 710, a symbol-to-bit mapper 712, a systematic FEC encoder 714, and a bit-to-symbol mapper 716. The transmit chain 700 may be used for, for example, ASK modulation with ASK constellations having a modulation order 2^{M}. In such an example, an ASK constellation for the modulation order 2^{M} may include a set of constellation points {±1, ±3, . . . , ±(2^{M}−1)} with an amplitude alphabet {1, 3, . . . , (2^{M}−1)}. In another example, the transmit chain 700 may be used for QAM modulation with a modulation order 2^{2M}, a set of constellation points {±1, ±3, . . . , ±(2^{M}−1)}×{±1, ±3, . . . , ±(2^{M}−1)}, and an amplitude alphabet {1, 3, . . . , 2^{M}−1}.

As further shown in FIG. 7, the energy-based amplitude shaper 710 may receive a sequence u^{k}=(u₁, u₂, . . . , uₖ) of k information bits. The sequence u^{k} represents a set of k information bits for encoding. The energy-based amplitude shaper 710 may determine a symbol sequence sⁿ with an energy E(sⁿ) that is constrained to be less than an energy threshold E. The symbol sequence sⁿ may represent a set of n amplitude symbols. In some examples, using an energy-based amplitude shaper can achieve a non-uniform symbol-wise marginal distribution of the n amplitude symbols that is closer to a capacity-achieving input distribution than when a uniform distribution is used as an input. The non-uniform symbol-wise marginal distribution may be the MB distribution for an AWGN channel. The symbol-to-bit mapper 712 may map the sequence sⁿ=(s₁, s₂, . . . , sₙ), which includes a set of n amplitude symbols, to (M−1) bit sequences of length n, denoted as

$$\{ {b}_{2}^{n} , {b}_{3}^{n} , … , {b}_{M}^{n} \} .$$

In other words, each of the n amplitude symbols corresponds to (M−1) bits, resulting in a total of n(M−1) amplitude bits.

The systematic FEC encoder 714 may receive the sets of bit sequences

$$\{ {b}_{2}^{n} , {b}_{3}^{n} , … , {b}_{M}^{n} \}$$

and a set of extra information bits u^{γn} (e.g., totaling n(M−1+γ)) for FEC encoding at a rate of R_{c}=(M−1+γ)/M. The systematic FEC encoder 714 generates an output set of n(1−γ) parity bits (or FEC bits) p^{n(1-γ)}, which maps to a bit sequence

$${b}_{1}^{n} .$$

The bit-to-symbol mapper 716 may receive the sets of bit sequences

$$\{ {b}_{2}^{n} , {b}_{3}^{n} , … , {b}_{M}^{n} \}$$

and the parity bit sequence

$${b}_{1}^{n}$$

and generate a set of symbols xⁿ. For example, the bit sequence

$${b}_{1}^{n}$$

can be converted to n sign bits, which are pointwise multiplied with the n amplitude symbols in sⁿ. A resulting transmission rate Rₜ of the transmit chain 700 is Rₜ=Rₐₛ+γ, where Rₐₛ represents a rate of receiving amplitude symbols for encoding. It is desirable to achieve a non-uniform distribution over the amplitude symbols, which can be achieved through selection of the energy threshold Ē.

As indicated above, FIG. 7 is provided as an example. Other examples may differ from what is described with regard to FIG. 7.

As described above, an amplitude alphabet [symbol] ₘ={a₁, a₂, . . . , aₘ} for m>1 can be used when encoding a set of information bits to generate a set of symbols. The amplitude alphabet [symbol] ₘ may be ordered such that aᵢ<aᵢ₊₁ for any i∈{1, 2, . . . , m−1} (e.g., a₁<a₂< . . . <aₘ). Each symbol of the amplitude alphabet [symbol] ₘ has a symbol energy E(aᵢ) that is also ordered such that 0≤E(aᵢ)<E(aᵢ₊₁) for any i∈{1, 2, . . . , m−1} (e.g., E(a₁)<E(a₂)< . . . <E(aₘ)). One example of a constellation that can be used for symbol mapping is a 2^{M}-ary ASK constellation [symbol] ₘ={1, 3, . . . , 2^{M}−1}, where m=2^{M}−1 and is based at least in part on the modulation order. Accordingly, aᵢ=2i−1, which results in a set of symbols a₁=1, a₂=3, . . . , aₘ=2^{M}−1.

Given an amplitude alphabet [symbol] ₘ of size m, a sequence may be constructed s=(s₁, s₂, . . . , sₙ) of length n over the amplitude alphabet [symbol] ₘ. In other words, each element of the sequence s belongs to the amplitude alphabet [symbol] ₘ. The energy of the sequence s, denoted E(s) is a sum of symbol energies within the sequence s:

$$E ( s ) = {\sum }_{l = 1}^{n} E ( {s}_{l} )$$

where sₗ is an element of the sequence s (e.g., l ranges from 1 to n). A sequence quantity {s=(s₁, s₂, . . . , sₙ)|sᵢ∈ [symbol] ₘ, i∈{1, 2, . . . , n}, E(s)=E} represents a set of all sequences of length n over the amplitude alphabet [symbol] ₘ such that each sequence in the set has an energy equal to E. The sequence quantity is a value N^{[m]}(n, E) (e.g., a total quantity of distinct sequences in the above-mentioned set of all sequences), which may also be denoted “N(n, E)” or “N” depending on the context, where, for a given value of m, N(n, E) is a two-variable integer-valued function of n and E. Similarly, a cumulative sequence quantity

$${N}_{c}^{[ m ]}$$

(n, E) (also denoted “N_{c}(n, E)” or “N_{c}” depending on the context) represents a set of all sequences of length n over [symbol] ₘ, such that each sequence in [symbol] (m, n, E) has an energy of at most E and is denoted as [symbol] (m, n, E)≙{s|sᵢ∈ [symbol] ₘ, i∈{1, 2, . . . , n}, E(s)≤E}. N may relate to N_{c} according to a relationship:

$${N}_{c}^{[ m ]} ( n , E ) = {\sum }_{{E}^{′} = 0}^{E} {N}^{[ m ]} ( {n}^{′} , {E}^{′} ) {N}_{c}^{[ m ]} ( n - {n}^{′} , E - {E}^{′} ) ,$$

where E(aₘ) represents a maximum symbol energy, such that 0≤E≤nE(aₘ) for 1≤n′≤n.

In some wireless communications, such as when higher-order modulations are used, a transmitter device may encode information bits using fixed constellation points. For example, fixed constellation points may be used with 16-QAM, 64-QAM, or 256-QAM, among other modulation and coding schemes. The fixed constellation points may each have an equal probability of being used for encoding the information bits. For AWGN channels, a shaping gap, which may be relative to a channel capacity or “Shannon capacity,” may be present that can asymptotically approach approximately 1.53 decibels (dB) for uniformly distributed channel inputs. The shaping gap may refer to a difference between a signal to noise ratio (SNR) to achieve a given rate with a given MCS and an SNR at which an optimal capacity-achieving scheme could operate, which may be the Shannon capacity or a “Shannon limit.”

Some techniques to reduce or close the shaping gap include geometric shaping and probabilistic shaping. In geometric shaping, a transmitter device may use equiprobable signaling with a non-uniform (for example, Gaussian-like) distribution of constellation points. In contrast, in probabilistic shaping, the transmitter device may use equidistant constellation points with non-uniform (for example, Gaussian-like) signal distribution. To perform probabilistic shaping, the transmitter device may determine an energy threshold E such that there is a non-uniform distribution over a set of amplitude symbols induced by an energy-based shaping scheme. If the non-uniform distribution is relatively different than an optimal MB distribution, the shaping gap may be excessively large, which may result in poor communication performance.

A probability distribution (such as an MB distribution) with a parameter v (a non-negative real number) over an amplitude alphabet [symbol] ₘ results in a probability distribution of the form

$${p}_{v} ( a ) = \frac{1}{{Z}_{v}} {e}^{- v E ( a )} ,$$

where a represents elements of [symbol] ₘ and Zᵥ is a normalizing constant. An optimal probability distribution over an ASK constellation, such as the ASK constellation described with reference to FIGS. 5 and 7, can exhibit a relatively large shaping gain over a uniform distribution for the same constellation. In other words, the uniform distribution has a shaping gap of some amount from the optimal probability distribution (for example, an MB distribution).

As described above, a set of encoded information bits may be associated with an amplitude alphabet [symbol] ₘ, a symbol sequence s, a sequence length n, and a total energy E. An energy threshold Ē may represent a constraint on the total energy E, such that [symbol] (m, n, Ē) can represent the set of all symbol sequences of length n and over an alphabet [symbol] ₘ such that the energy of each sequence is at most equal to an energy threshold Ē. A transmitter device may perform energy-based shaping, and may use, for the encoding, a direct energy-based arithmetic coding (AC) method or a two-stage peeling method. A distribution matcher of the transmitter device, such as distribution matchers 510 and 610 can implement one of the aforementioned example techniques. In such examples, a distribution mapper induces an injective mapping from the set of all 2^{k} possible information bit sequences to [symbol] (m, n, Ē). A consequence of such encoding is unique decodability is guaranteed at the receiver device by imposing conditions on k in terms of m, n, and Ē. However, the encoding methods described above are implemented as a serial process. For example, the underlying direct energy-based AC method is a serially implemented method, which may result in excess latency to encode and transmit latency-sensitive communications.

In some aspects, a WCD may encode a communication using finite-precision energy-based arithmetic encoding. In some aspects, precision may be made finite to conserve processing resources and power resources, and to improve latency for encoding information bits. For example, if 1,000 bits are to be encoded, some aspects of energy-based arithmetic encoding may become too complex based at least in part on limited latency requirements, power resources, and/or processing resources. For this reason, finite-precision energy-based arithmetic encoding may be used for energy-based arithmetic encoding.

In an example of finite-precision energy-based arithmetic encoding, given an alphabet [symbol] ₘ of size m, a sequence length n and a maximum sequence energy Ē, finite-precision energy-based arithmetic encoding may be used to encode a plurality of k information bits to a sequence of length n, with each element of the sequence belonging to [symbol] ₘ, and the energy of the sequence being at most equal to Ē. Encoding proceeds in iterations to sequentially determine n output symbols.

Each iteration may include approximating one or more logarithms of cumulative sequence quantities and exponentiating the logarithm of cumulative sequence quantities to respectively obtain one or more Kₐ-bit numbers. In these operations, the WCD may use a finite precision to estimate the one or more logarithms of the cumulative sequence quantities. This may be based at least in part on the circumstance that identifying cumulative sequence quantities with perfect accuracy may not be feasible based at least in part on computing and power resources that would be consumed and a latency in performing a calculation at each iteration.

Each iteration may further include computing one or more partial sums (e.g., of the cumulative sequence quantities) to respectively obtain one or more K_{S}-bit numbers, identifying a renormalization factor that is a Kₛ-bit number, identifying one or more intervals with interval boundaries as K_{X}-bit numbers, and determining an output symbol by determining a symbol index as an integer such that a difference between an information integer and an interval boundary is nonnegative (e.g., an a smallest possible value), the interval boundary corresponding to the integer.

Each iteration may further include updating values used in the iteration. For example, the WCD may update a residual sequence counter as a K_{S}-bit number, update a residual sequence length, update a residual maximum sequence energy, and/or update the information integer, among other examples.

The WCD may proceed with iterations until each member of the sequence is identified. The iterations may each be associated with identification of a single symbol of the sequence, such that a number of iteration is equal to the length n.

As described herein, a K-bit number is a positive integer z that satisfies the following conditions: z can be written in the form of z=a2^{l}, K is an integer such that K≥2, a is a K-bit unsigned integer such that a is either equal to 0 or the most-significant bit (MSB) in the binary expansion of a is 1, and l is an integer such that l>−K. Additionally, 0≤a≤2^{K}−1. For example, z=2503×2²⁴⁶⁹⁶ can be viewed as a 12-bit number. In this example, a binary expansion of 2503 can be written as (1, 0, 0, 1, 1, 1, 0, 0, 0, 1, 1, 1), and a binary expansion of 24696 can be written as (0, 1, 1, 0, 0, 0, 0, 0, 0, 1, 1, 1, 1, 0, 0, 0). Additionally, or alternatively, if K₁≥K₂, then any K₂-bit number can be exactly represented as a K₁-bit number.

The WCD may operate on the K-bit numbers based at least in part on being K-bit numbers. For example, upward addition may be performed. Let z₁=a₁2^{l}^{₁} and z₂=a₁2^{l}^{₂} be K-bit numbers; assume without loss of generality that z₁≥z₂. The upward addition operation, denoted by Ā_{K}, is a pairwise operation. It takes as its input two K-bit numbers and determines a K-bit number as its output. If a₁+a₂2^{l}^{₂}^{-l}^{₁}≤2^{K}−1, then Ā_{K}(z₁, z₂)=┌a₁+a₂2^{l}^{₂}^{-l}^{₁}>2^{l}^{₁}. If a₁+a₂2^{l}^{₂}^{-l}^{₁}>2^{K}−1, then Ā_{K}(z₁,z₂)=┌(a₁+a₂2^{l}^{₂}^{-l}^{₁})/2┐2^{l}^{₁}⁺¹.

In another example, downward addition may be performed. Let z₁=a₁2^{l}^{₁} and z₂=a₂2^{l}^{₂} be K-bit numbers; assume without loss of generality that z₁≥z₂. The downward addition operation, denoted by A_{K}, is a pairwise operation. It takes as its input two K-bit numbers and determines a K-bit number as its output. If a₁+a₂2^{l}^{₂}^{-l}^{₁}<2^{K}, then A_{K}(z₁,z₂)=└a₁+a₂2^{l}^{₂}^{-l}^{₁}┘2^{l}^{₁}. If a₁+a₂2^{l}^{₂}^{-l}^{₁}≥2^{K}, then A_{K}(z₁, z₂)=└(a₁+a₂2^{l}^{₂}^{-l}^{₁})/2┘2^{l}^{₁}¹⁺¹.

In another example, upward and downward multiplication may be performed. Let z₁=a₁2^{l}^{₁} and z₂=a₂2^{l}^{₂} be K-bit numbers; if either a₁=0 or a₂=0 then the result is 0; so, assume that this is not the case. There exists an L∈{2K−1, 2K} such that 2^{L-1}≤a₁a₂<2^{L}. Upward multiplication operation, denoted by M̅_{K}, is a pairwise operation defined as M̅_{K}(z₁, z₂)=┌a₁a₂2^{K-L}┐2^{l}^{₁}^{+l}^{₂}^{+L-K}. Downward multiplication operation, denoted by M_{K}, is a pairwise operation defined as M_{K}(z₁, z₂)=└a₁a₂2^{K-L}┘2^{l}^{₁}^{+l}^{₂}^{+L-K}.

In another example, upward and downward division may be performed. Let z₁=a₁2^{l}^{₁} and z₂=a₂2^{l}^{₂} be K-bit numbers; assume that a₁≠0 or a₂≠0. There exists an L∈{0, 1} such that

$$1 \leq \frac{{a}_{1}}{{a}_{2}} {2}^{L} \leq 2 - {2}^{1 - K} .$$

Upward division operation, denoted by D̅_{K}, is a pairwise operation defined as

$${\overline{D}}_{K} ( {z}_{1} , {z}_{2} ) = ⌈ \frac{{a}_{1}}{{a}_{2}} {2}^{K - 1 - L} ⌉ {2}^{{l}_{1} + {l}_{2} + L + 1 - K} .$$

The downward division operation, denoted by D_{K}, is a pairwise operation defined as

$${\underline{D}}_{K} ( {z}_{1} , {z}_{2} ) = ⌊ \frac{{a}_{1}}{{a}_{2}} {2}^{K - 1 - L} ⌋ {2}^{{l}_{1} + {l}_{2} + L + 1 - K} .$$

Returning to the finite-precision energy-based arithmetic encoding process, parameters and/or a configuration may be established between the WCD and a receiving WCD. For example, the parameters may include inputs, such as a definition of an alphabet [symbol] ₘ, a sequence length n and a maximum sequence energy Ē. Integer-valued parameters Kₐ, K_{S}, Kₛ and K_{X} may be defined for finite-precision configurations, and parameter η may be defined to cause unique decodability of encoded bits. In an example, Kₐ=12, K_{S}=Kₛ=K_{X}=16 (e.g., a relatively small number compared to a size of an integer representation of information bits to be encoded) and η=0.001.

The parameters may further include a parametric function log₂ U_{c} of two variables n and E associated with [symbol] ₘ. The K parameters have values that indicate a number of bits allowed to indicate the values.

With the parameters established, the WCD may initialize encoding. The WCD may approximate a logarithm of a cumulative sequence quantity log₂ N_{c}(n, Ē), and denote the approximation by log₂ \hat{N}_{c}(n, Ē). A cumulative sequence quantity N_{c}(n, Ē) may be a cardinality of [symbol] (m, n, Ē) and counts the total number of sequences such that 1) each element of each such sequence belongs to [symbol] ₘ, 2) each such sequence has length n, and 3) each such sequence has energy less than or equal to Ē.

The WCD may determine k as the largest integer such that the following condition holds: k+n log₂(1+η)+log₂ U_{c}(n, Ē)≤log₂ \hat{N}_{c}(n, Ē). The WCD may obtain a plurality of k information bits u₁, u₂, . . . , uₖ. The k bits may be interpreted as an unsigned integer x∈[0, 2^{k}), which are both available for encoding.

The WCD may use the finite-precision encoding method to encode the k bits u₁, u₂, . . . , uₖ to a symbol sequence sⁿ=(s₁, s₂, . . . , sₙ) in [symbol] (m, n, Ē).

The finite-precision encoding consists of n sequential iterations. An iteration index j is initialized as j=0. A residual sequence length nⱼ is associated to iteration index j and is initialized as nⱼ=n. A residual maximum sequence energy Eⱼ is associated to iteration index j and is initialized as Eⱼ=Ē. A residual sequence counter Mⱼ is associated to iteration index j and is initialized as Mⱼ=2^{k}. An information integer xⱼ is associated to iteration index j and is initialized as xⱼ=x, with each integer xⱼ referred to as the information integer or an updated information integer.

The finite-precision encoding iterates the following until and including j=n−1. Iteration j approximates one or more logarithm of cumulative sequence quantities log₂ N_{c}(nⱼ−1, Eⱼ−E(aᵢ)), aᵢ∈ [symbol] ₘ. Each such cumulative sequence quantity corresponds to a respective symbol in the alphabet [symbol] ₘ (e.g., each cumulative sequence quantity is a sum of sequence quantities associated with a symbol of the alphabet [symbol] ₘ). The plurality is equal to the size m of the alphabet [symbol] ₘ (e.g., there is a number of cumulative sequence quantities that is equal to a number of symbols of the alphabet [symbol] ₘ).

Denote an approximation of log₂ N_{c}(nⱼ−1, Eⱼ−E(aᵢ)) by log₂ \hat{N}_{c}(nⱼ−1, Eⱼ−E(aᵢ)). Each approximation is represented as a fixed-point number with 1 sign bit, Qᵢ bits for integer part and Q_{f} bits for fractional part. Iteration j exponentiates the one or more approximations to obtain one or more Kₐ-bit numbers. Each approximation corresponds to a respective Kₐ-bit number. The Kₐ-bit number corresponding to log₂ \hat{N}_{c}(nⱼ−1, E₁−E(aᵢ)) is denoted by N_{c}(nⱼ−1, Eⱼ−E(aᵢ)) and also by \hat{B}ₘ₋ᵢ₊₁. Given that E(aᵢ)<E(aᵢ₊₁), the Kₐ-bit numbers \hat{B}ᵢ are in increasing order, e.g., \hat{B}ᵢ<\hat{B}ᵢ₊₁. Dependence on the iteration index j is omitted for notational simplicity.

During iteration j, the WCD computes one or more partial sums based on K_{S} and the Kₐ-bit numbers \hat{B}ᵢ using a downward addition operation A_{K}_{_{S}}. The plurality is equal to the size m of the alphabet [symbol] ₘ.

The WCD may initialize S₀=0 and for i∈{1, 2, . . . , m}, compute a partial sum Sᵢ=A_{K}_{_{S}}(Sᵢ₋₁, \hat{B}ᵢ). Each partial sum is a K_{S}-bit number. The WCD computes, for iteration j, a renormalization factor s′ based at least in part on Kₛ, the sequence counter Mⱼ and the partial sum Sₘ using an upward division operation D̅_{K}_{ₛ}: s′=D̅_{K}_{ₛ}(Mⱼ, Sₘ).

Also as part of iteration j, the WCD computes one or more K_{X}-bit numbers X₁, X₂, . . . , Xₘ based on K_{X}, the renormalization factor s′ and the partial sums Sᵢ using an upward multiplication operation M̅_{K}_{_{X}}: Xᵢ=M̅_{K}_{_{X}}(s′, Sⱼ). The one or more K_{X}-bit numbers X₁, X₂, . . . , Xₘ is equal to the size m of the alphabet [symbol] ₘ. Also, 0=X₀≤X₁≤ . . . ≤Xₘ.

During iteration j, the WCD formulates one or more intervals of the form [Xᵢ₋₁, Xᵢ). The plurality has a number of members equal to m of the alphabet [symbol] ₘ. Each respective interval corresponds to a symbol in the alphabet [symbol] ₘ (e.g., interval [Xᵢ₋₁, Xᵢ) corresponds to symbol aᵢ). The length of the interval [Xᵢ₋₁, Xᵢ) corresponds to an estimate of the number of uniquely decodable sequences of length nⱼ−1 and energy at most Eⱼ−E(aᵢ).

The WCD then determines an index i such that Xᵢ₋₁≤xⱼ<Xᵢ. In other words, the information integer xⱼ associated to iteration index j lies within the interval [Xᵢ₋₁, Xᵢ). The determination of the index i is based at least in part on comparing the difference xⱼ−Xᵢ₋₁ with 0. Since the K_{X}-bit numbers Xᵢs have some fixed width K_{X}, it follows that judging whether xⱼ−Xᵢ₋₁≥0 holds for any i∈{1, 2, . . . , m} only involves a fixed amount of computations. The WCD then computes a renormalization factor s based on Kₛ, the renormalization factor s′=a2^{l} and an integer c≥2 using an upward addition operation Ā_{K}_{ₛ}: s=Ā_{K}_{ₛ}(s′, 2^{l+c}). The integer c satisfies 2^{c-K}^{ₛ}≥m2^{1-K}^{_{X}}.

The WCD continues iteration j by determining symbol sⱼ₊₁=aᵢ as an output symbol, where the symbol of the sequence is a symbol of the alphabet [symbol] ₘ. The WCD then determines a residual sequence counter Mⱼ₊₁ associated to iteration index j+1 based on Kₛ, the renormalization factor s and the approximation \hat{B}ᵢ that corresponds to symbol aᵢ, where i is the determined index, using an upward multiplication operation M̅_{K}_{ₛ}: Mⱼ₊₁=M̅_{K}_{ₛ}(s, \hat{B}ᵢ), where Mⱼ₊₁ is a Kₛ-bit number.

The WCD determines a residual sequence length nⱼ₊₁ that is associated to iteration index j+1 by nⱼ₊₁=nⱼ−1, updates a residual maximum sequence energy Eⱼ₊₁ that is associated to iteration index j+1 by Eⱼ₊₁=Eⱼ−E(aᵢ), updates the information integer xⱼ associated to iteration index j to an information integer xⱼ₊₁ associated to iteration index j+1 by computing a subtraction xⱼ₊₁=xⱼ−Xᵢ₋₁. In other words, for a subsequent iteration, the information integer is updated to be a difference between the information integer (e.g., of a current iteration) and an interval boundary of an interval that includes the value of the information integer.

The iteration index j is then increased by 1, meaning that a next iteration is to begin. This completes the operations for iteration j and a subsequent iteration is ready to begin. The finite-precision encoding advances to the next iteration and proceeds accordingly until j reaches n, where all symbols of the sequence have been selected to encode the information bits, at which point encoding stops.

FIG. 8 is a diagram of an example 800 associated with finite-precision energy-based arithmetic encoding, in accordance with the present disclosure. As shown in FIG. 8, a WCD (e.g., a UE, a network node 110, a CU, a DU, and/or an RU) may communicate with a receiver device (e.g., a UE, a network node 110, a CU, a DU, and/or an RU). In some aspects, the WCD and the receiver device may be part of a wireless network (e.g., wireless network 100). The WCD and the receiver device may have established a wireless connection prior to operations shown in FIG. 8.

As shown by reference number 805, the WCD and the receiver device may transmit and/or receive an indication of parameters for finite-precision energy-based arithmetic encoding. In some aspects, the finite-precision energy-based arithmetic encoding may be associated with probabilistic amplitude shaping that is associated with the maximum sequence energy.

In some aspects, the WCD and the receiver device may communicate the parameters via one or more of RRC signaling, one or more MAC control elements (CEs), downlink control information (DCI), and/or sidelink control information (SCI), among other examples. In some aspects, the parameters may include an indication of one or more configuration parameters (e.g., already known to the WCD and/or previously indicated by the receiver device) for selection by the receiver device and/or the WCD. In some aspects, the parameters may include an explicit indication of the parameters to configure finite-precision energy-based arithmetic encoding. For example, the indication of the parameters may include an index that maps to the parameters, an explicit indication of the parameters (e.g., an indication of each parameter), and/or an implicit indication of the parameters.

In some aspects, the parameters may include Kₐ, K_{S}, Kₛ and K_{X}, and/or parameter η. These parameters may be associated with a precision of the finite-precision energy-based arithmetic encoding. Additionally, or alternatively, parameters may cause unique decodability of encoded bits using the finite-precision energy-based arithmetic encoding. In some aspects, the parameters may include a maximum sequence energy of a set of symbols of a sequence of amplitude symbols.

As shown by reference number 810, the WCD may receive bits (e.g., with a quantity of k bits) for encoding. For example, the bits for encoding may be referred to as information bits that include the information that the WCD is to encode and transmit to the receiver device. In some aspects, the WCD may encode the bits based at least in part on the parameters described in connection with reference number 805.

In some aspects, the WCD may perform subsequent operations to encode the bits. The WCD may encode the bits into a sequence having a length (e.g., n), which length may be 2 to the power of an integer.

As shown by reference number 815, the WCD may identify an information integer associated with the bits. The information integer may be an unsigned integer representation of the information bits in decimal form.

As shown by reference number 820, the WCD may identify one or more quantities, having finite precisions, of candidate sequences based at least in part on the parameters. For example, the WCD may identify one or more quantities of candidate sequences having a length of remaining symbols of the sequence after selecting a symbol of the sequence of symbols, having members included in the set of symbols, and satisfying a remaining amount of a maximum sequence energy after using the selected symbol. The finite precision may be based at least in part on values of the parameters.

In some aspects, the WCD may identify the one or more quantities (e.g., with an approximation that is based at least in part on the parameters) based at least in part on approximating one or more logarithms of the one or more quantities of candidate sequences and exponentiating the one or more logarithms of the one or more quantities of candidate sequences. The WCD may obtain one or more Kₐ-bit numbers corresponding to approximations of logarithms of the one or more quantities of candidate sequences. The Kₐ-bit number may be a K-bit number, where a product of a first number and a second number, and wherein the second number is equal to 2 to the power of a third number that is a positive integer. In some aspects, the WCD may exponentiate the approximate logarithms of the one or more quantities of candidate sequences. In this way, computational complexity would be lower based at least in part on the logarithm and exponentiation operations providing a finite precision to the one or more quantities of candidate sequences.

The WCD may compute a renormalization factor based at least in part on a K_{S}-bit number associated with the partial sums, a sequence counter, and the partial sums using an upward division operation. The WCD may then compute one or more Kₓ-bit numbers based at least in part on a value associated with the renormalization factor and the partial sums using an upward multiplication operation.

In some aspects, each quantity of the quantities of candidate sequences is associated with a respective energy of the set of symbols. Additionally, or alternatively, a number of quantities of candidate sequences is based at least in part on a number of symbols of the set of symbols.

As shown by reference number 825, the WCD may identify interval boundaries using partial sums of the one or more quantities. For example, a first interval boundary may be 0, a second interval boundary may be an estimated number of candidate sequences that may be used (e.g., based at least in part on satisfying the maximum energy) for remaining elements of the sequence if a highest energy symbol is selected for a symbol value at position j of the sequence. A third interval boundary may be an estimated number of candidate sequences that may be used for remaining elements of the sequence if a second highest energy symbol is selected for a symbol value at position j of the sequence. Additional interval boundaries may be similarly calculated and estimated.

In some aspects, the WCD may identify one or more intervals having the interval boundaries, an interval corresponding to a candidate value of the set of symbols for a symbol being selected in a current iteration.

In some aspects, the partial sums are associated with a sum of an approximated quantity of candidate sequences that satisfy the remaining energy if a candidate symbol is selected and one or more approximated quantities of candidate sequences that satisfy the remaining energy if one or more additional candidate symbols having higher energy than the candidate symbol are selected. Each partial sum is a K_{S}-bit number, wherein a K_{S}-bit number is a K-bit number.

As shown by reference number 830, the WCD may select a symbol for the sequence to be transmitted (e.g., at position j for iteration j). For example, the WCD may select a symbol of the sequence of symbols based at least in part on the interval boundaries and an information integer to be encoded. The symbol may be the symbol associated with an interval formed by consecutive boundaries, with an upper boundary indicating a cumulative sum of candidate sequences that may be selected if the symbol or a symbol having higher energy is selected as the symbol at iteration j. For example, the WCD may identify an interval, between a first interval boundary and a second interval boundary of the interval boundaries of the partial sums, that includes an information integer. The WCD may select the symbol based at least in part on the symbol being associated with the interval. In some aspects, the first interval boundary and the second interval boundary comprise Kₓ-bit numbers, which are K-bit numbers.

In some aspects, the symbol may be selected from a set of symbols (e.g., an alphabet of symbols) associated with energies and/or amplitudes of a transmitted signal.

As shown by reference number 835, the WCD may update values based at least in part on the symbol. In some aspects, the WCD may update (e.g., by subtracting an energy associated with the selected symbol) a remaining amount of the maximum sequence energy (used in a subsequent iteration to identify candidate sequences that satisfy the remaining amount of maximum sequence energy for remaining symbols of the sequence). In some aspects, the WCD may update a length of remaining symbols of the sequence (e.g., by subtracting 1), update the quantity of the candidate sequences (based at least in part on the updated length and the updated remaining amount of the maximum sequence energy), and/or update an information integer used to select the symbol of the sequence of symbols (e.g., based at least in part on subtracting a lower interval boundary value of an interval associated with the selected symbol).

As shown by reference number 840, the WCD may iterate until all members of the sequence are selected.

As shown by reference number 845, the WCD may send the encoded symbols for transmission. The encoded symbols may be encoded using the received bits for encoding and iterative encoding operations (e.g., shown in one or more of operations 815-835). In some aspects, a number of iterations of the operations is less than or equal to a length of the sequence of symbols.

As shown by reference number 850, the WCD may transmit, and the receiver device may receive, a communication that includes the sequence of symbols encoded with finite-precision energy-based arithmetic encoding.

Based at least in part on encoding the bits into the sequence of symbols using finite-precision energy-based arithmetic encoding, the WCD may conserve processing resources and power resources, and to improve latency for encoding information bits.

As indicated above, FIG. 8 is provided as an example. Other examples may differ from what is described with respect to FIG. 8.

FIG. 9 is a diagram illustrating an example process 900 performed, for example, by a WCD, in accordance with the present disclosure. Example process 900 is an example where the WCD (e.g., UE 120 or network node 110) performs operations associated with finite-precision energy-based arithmetic encoding.

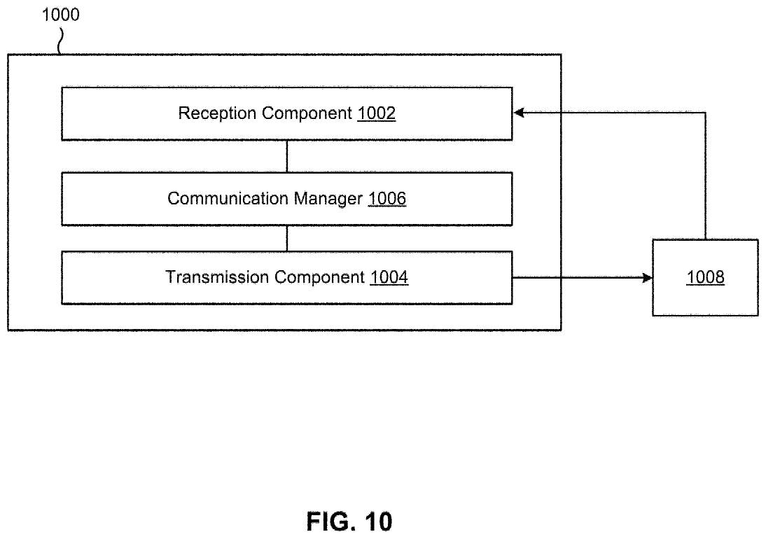

As shown in FIG. 9, in some aspects, process 900 may include encoding a set of bits to a sequence of symbols, members of the sequence of symbols included in a set of symbols, the encoding using finite-precision energy-based arithmetic encoding and including iterative operations comprising: identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identifying interval boundaries based at least in part on partial sums of the one or more quantities; and selecting a symbol of the sequence of symbols based at least in part on the interval boundaries and an information integer to be encoded, the information integer being based at least in part on an integer representation of the set of bits (block 910). For example, the WCD (e.g., using communication manager 140 or 150, or communication manager 1006, depicted in FIG. 10) may encode a set of bits to a sequence of symbols, members of the sequence of symbols included in a set of symbols, the encoding using finite-precision energy-based arithmetic encoding and including iterative operations comprising: identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identifying interval boundaries based at least in part on partial sums of the one or more quantities; and selecting a symbol of the sequence of symbols based at least in part on the interval boundaries and an information integer to be encoded, the information integer being based at least in part on an integer representation of the set of bits, as described above.

As further shown in FIG. 9, in some aspects, process 900 may include transmitting a communication that includes the sequence of symbols encoded with the finite-precision energy-based arithmetic encoding (block 920). For example, the WCD (e.g., using transmission component 1004 and/or communication manager 1006, depicted in FIG. 10) may transmit a communication that includes the sequence of symbols encoded with the finite-precision energy-based arithmetic encoding, as described above.

Process 900 may include additional aspects, such as any single aspect or any combination of aspects described below and/or in connection with one or more other processes described elsewhere herein.

In a first aspect, the iterative operations further include, based at least in part on selecting the symbol of the sequence of symbols, one or more of updating a remaining amount of the maximum sequence energy, updating the length of remaining symbols of the sequence, updating the quantity of the candidate sequences, or updating an information integer used to select the symbol of the sequence of symbols.

In a second aspect, alone or in combination with the first aspect, the iterative operations comprise a number of iterations of the operations that is less than or equal to a length of the sequence of symbols.

In a third aspect, alone or in combination with one or more of the first and second aspects, each quantity of the quantities of candidate sequences is associated with a respective energy of the set of symbols, and wherein a number of quantities of candidate sequences is based at least in part on a number of symbols of the set of symbols.

In a fourth aspect, alone or in combination with one or more of the first through third aspects, process 900 includes transmitting an indication of parameters for finite-precision energy-based arithmetic encoding, one of the parameters including a maximum sequence energy of a set of symbols of a sequence of amplitude symbols.

In a fifth aspect, alone or in combination with one or more of the first through fourth aspects, the iterative operations encode the set of bits based at least in part on the parameters.

In a sixth aspect, alone or in combination with one or more of the first through fifth aspects, transmitting the indication of parameters comprises one or more of transmitting an index that maps to the parameters, transmitting an explicit indication of the parameters, or transmitting an implicit indication of the parameters.

In a seventh aspect, alone or in combination with one or more of the first through sixth aspects, the energy-based arithmetic encoding is associated with probabilistic amplitude shaping that is associated with the maximum sequence energy.

In an eighth aspect, alone or in combination with one or more of the first through seventh aspects, the iterative operations further comprise one or more of approximating one or more logarithms of the one or more quantities of candidate sequences, exponentiating (e.g., an exact or approximate exponentiation of) the one or more logarithms of the one or more quantities of candidate sequences, obtaining one or more Kₐ-bit numbers corresponding to approximations of logarithms of the one or more quantities of candidate sequences, wherein a Kₐ-bit number is a product of a first number, having a binary expansion that has a length Kₐ, and a second number, and wherein the second number is equal to 2 to the power of a third number that is a positive integer, computing a renormalization factor based at least in part on a K_{S}-bit number associated with the partial sums, a sequence counter, and the partial sums using an upward division operation, computing one or more Kₓ-bit numbers based at least in part on a value associated with the renormalization factor and the partial sums using an upward multiplication operation, or identifying one or more intervals having the interval boundaries, an interval corresponding to a candidate value of the set of symbols for a symbol being selected in a current iteration.

In a ninth aspect, alone or in combination with one or more of the first through eighth aspects, the partial sums are associated with a sum of an approximated quantity of candidate sequences that satisfy the remaining energy if a candidate symbol is selected and one or more approximated quantities of candidate sequences that satisfy the remaining energy if one or more additional candidate symbols having higher energy than the candidate symbol are selected, and wherein each partial sum is a K_{S}-bit number, wherein a K_{S}-bit number is a product of a first number, having a binary expansion that has a length K_{S}, and a second number, wherein the second number is equal to 2 to the power of a third number that is a positive integer.

In a tenth aspect, alone or in combination with one or more of the first through ninth aspects, the sequence of symbols has a length that is 2 to the power of an integer.

In an eleventh aspect, alone or in combination with one or more of the first through tenth aspects, selecting the symbol of the sequence of symbols comprises identifying an interval, between a first interval boundary and a second interval boundary of the interval boundaries of the partial sums, that includes an information integer, and selecting the symbol based at least in part on the symbol being associated with the interval.

In a twelfth aspect, alone or in combination with one or more of the first through eleventh aspects, the first interval boundary and the second interval boundary comprise Kₓ-bit numbers, wherein a Kₓ-bit number is a product of a first number, having a binary expansion that has a length Kₓ, and a second number, and wherein the second number is equal to 2 to the power of a third number that is a positive integer.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a WCD, or a WCD may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 or 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the WCD described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the WCD described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the WCD described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may encode a set of bits to a sequence of symbols, members of the sequence of symbols included in a set of symbols, the encoding using finite-precision energy-based arithmetic encoding and including iterative operations comprising identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identifying interval boundaries based at least in part on partial sums of the one or more quantities; and selecting a symbol of the sequence of symbols based at least in part on the interval boundaries and an information integer to be encoded, the information integer being based at least in part on an integer representation of the set of bits. The transmission component 1004 may transmit a communication that includes the sequence of symbols encoded with the finite-precision energy-based arithmetic encoding.

The transmission component 1004 may transmit an indication of parameters for finite-precision energy-based arithmetic encoding, one of the parameters including a maximum sequence energy of a set of symbols of a sequence of amplitude symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a wireless communication device (WCD), comprising: encoding a set of bits to a sequence of symbols, members of the sequence of symbols included in a set of symbols, the encoding using finite-precision energy-based arithmetic encoding and including iterative operations comprising: identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identifying interval boundaries based at least in part on partial sums of the one or more quantities; and selecting a symbol of the sequence of symbols based at least in part on the interval boundaries and an information integer to be encoded, the information integer being based at least in part on an integer representation of the set of bits; and transmitting a communication that includes the sequence of symbols encoded with the finite-precision energy-based arithmetic encoding.

Aspect 2: The method of Aspect 1, wherein the iterative operations further include, based at least in part on selecting the symbol of the sequence of symbols, one or more of: updating a remaining amount of the maximum sequence energy, updating the length of remaining symbols of the sequence, updating the quantity of the candidate sequences, or updating an information integer used to select the symbol of the sequence of symbols.

Aspect 3: The method of any of Aspects 1-2, wherein the iterative operations comprise a number of iterations of the operations that is less than or equal to a length of the sequence of symbols.

Aspect 4: The method of any of Aspects 1-3, wherein each quantity of the quantities of candidate sequences is associated with a respective energy of the set of symbols, and wherein a number of quantities of candidate sequences is based at least in part on a number of symbols of the set of symbols.

Aspect 5: The method of any of Aspects 1-4, further comprising: transmitting an indication of parameters for finite-precision energy-based arithmetic encoding, one of the parameters including a maximum sequence energy of a set of symbols of a sequence of amplitude symbols.

Aspect 6: The method of Aspect 5, wherein the iterative operations encode the set of bits based at least in part on the parameters.

Aspect 7: The method of Aspect 5, wherein transmitting the indication of parameters comprises one or more of: transmitting an index that maps to the parameters, transmitting an explicit indication of the parameters, or transmitting an implicit indication of the parameters.

Aspect 8: The method of any of Aspects 1-7, wherein the energy-based arithmetic encoding is associated with probabilistic amplitude shaping that is associated with the maximum sequence energy.

Aspect 9: The method of any of Aspects 1-8, wherein the iterative operations further comprise one or more of: approximating one or more logarithms of the one or more quantities of candidate sequences; exponentiating the one or more logarithms of the one or more quantities of candidate sequences; obtaining one or more Kₐ-bit numbers corresponding to approximations of logarithms of the one or more quantities of candidate sequences, wherein a Kₐ-bit number is a product of a first number, having a binary expansion that has a length Kₐ, and a second number, and wherein the second number is equal to 2 to the power of a third number that is a positive integer; computing a renormalization factor based at least in part on a K_{S}-bit number associated with the partial sums, a sequence counter, and the partial sums using an upward division operation; computing one or more Kₓ-bit numbers based at least in part on a value associated with the renormalization factor and the partial sums using an upward multiplication operation; or identifying one or more intervals having the interval boundaries, an interval corresponding to a candidate value of the set of symbols for a symbol being selected in a current iteration.

Aspect 10: The method of any of Aspects 1-9, wherein the partial sums are associated with a sum of an approximated quantity of candidate sequences that satisfy the remaining energy if a candidate symbol is selected and one or more approximated quantities of candidate sequences that satisfy the remaining energy if one or more additional candidate symbols having higher energy than the candidate symbol are selected, and wherein each partial sum is a K_{S}-bit number, wherein a K_{S}-bit number is a product of a first number, having a binary expansion that has a length K_{S}, and a second number, wherein the second number is equal to 2 to the power of a third number that is a positive integer.

Aspect 11: The method of any of Aspects 1-10, wherein the sequence of symbols has a length that is 2 to the power of an integer.

Aspect 12: The method of any of Aspects 1-11, wherein selecting the symbol of the sequence of symbols comprises: identifying an interval, between a first interval boundary and a second interval boundary of the interval boundaries of the partial sums, that includes an information integer; and selecting the symbol based at least in part on the symbol being associated with the interval.

Aspect 13: The method of Aspect 12, wherein the first interval boundary and the second interval boundary comprise Kₓ-bit numbers, wherein a Kₓ-bit number is a product of a first number, having a binary expansion that has a length Kₓ and a second number, and wherein the second number is equal to 2 to the power of a third number that is a positive integer.

Aspect 14: An apparatus for wireless communication at a device, comprising a processor; memory coupled with the processor; and instructions stored in the memory and executable by the processor to cause the apparatus to perform the method of one or more of Aspects 1-13.

Aspect 15: A device for wireless communication, comprising a memory and one or more processors coupled to the memory, the one or more processors configured to perform the method of one or more of Aspects 1-13.

Aspect 16: A device for wireless communication, comprising memory, and one or more processors coupled to the memory, the memory comprising instructions executable by the one or more processors to cause the device to perform the method of one or more of Aspects 1-13.

Aspect 17: An apparatus for wireless communication, comprising at least one means for performing the method of one or more of Aspects 1-13.

Aspect 18: A non-transitory computer-readable medium storing code for wireless communication, the code comprising instructions executable by a processor to perform the method of one or more of Aspects 1-13.

Aspect 19: A non-transitory computer-readable medium storing a set of instructions for wireless communication, the set of instructions comprising one or more instructions that, when executed by one or more processors of a device, cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a wireless communication device (WCD), comprising:
encoding a set of bits to a sequence of symbols, members of the sequence of symbols included in a set of symbols, the encoding using finite-precision energy-based arithmetic encoding and including iterative operations comprising: identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions; identifying interval boundaries based at least in part on partial sums of the one or more quantities; and
selecting a symbol of the sequence of symbols based at least in part on the interval boundaries and an information integer to be encoded, the information integer being based at least in part on an integer representation of the set of bits; and
transmitting a communication that includes the sequence of symbols encoded with the finite-precision energy-based arithmetic encoding.

2. The method of claim 1, wherein the iterative operations further include, based at least in part on selecting the symbol of the sequence of symbols, one or more of:
updating a remaining amount of the maximum sequence energy,
updating the length of remaining symbols of the sequence,
updating the quantity of the candidate sequences, or
updating an information integer used to select the symbol of the sequence of symbols.

3. The method of claim 1, wherein the iterative operations comprise a number of iterations of the operations that is less than or equal to a length of the sequence of symbols.

4. The method of claim 1, wherein each quantity of the quantities of candidate sequences is associated with a respective energy of the set of symbols, and wherein a number of quantities of candidate sequences is based at least in part on a number of symbols of the set of symbols.

5. The method of claim 1, further comprising:
transmitting an indication of parameters for finite-precision energy-based arithmetic encoding, one of the parameters including a maximum sequence energy of a set of symbols of a sequence of amplitude symbols.

6. The method of claim 5, wherein the iterative operations encode the set of bits based at least in part on the parameters.

7. The method of claim 5, wherein transmitting the indication of parameters comprises one or more of:
transmitting an index that maps to the parameters,
transmitting an explicit indication of the parameters, or
transmitting an implicit indication of the parameters.

8. The method of claim 1, wherein the energy-based arithmetic encoding is associated with probabilistic amplitude shaping that is associated with the maximum sequence energy.

9. The method of claim 1, wherein the iterative operations further comprise one or more of:
approximating one or more logarithms of the one or more quantities of candidate sequences;
exponentiating the one or more logarithms of the one or more quantities of candidate sequences;
obtaining one or more Kₐ-bit numbers corresponding to approximations of logarithms of the one or more quantities of candidate sequences, wherein a Kₐ-bit number is a product of a first number, having a binary expansion that has a length Kₐ, and a second number, and wherein the second number is equal to 2 to the power of a third number that is a positive integer;
computing a renormalization factor based at least in part on a Kₛ-bit number associated with the partial sums, a sequence counter, and the partial sums using an upward division operation;
computing one or more Kₓ-bit numbers based at least in part on a value associated with the renormalization factor and the partial sums using an upward multiplication operation; or
identifying one or more intervals having the interval boundaries, an interval corresponding to a candidate value of the set of symbols for a symbol being selected in a current iteration.

10. The method of claim 1, wherein the partial sums are associated with a sum of an approximated quantity of candidate sequences that satisfy the remaining energy if a candidate symbol is selected and one or more approximated quantities of candidate sequences that satisfy the remaining energy if one or more additional candidate symbols having higher energy than the candidate symbol are selected, and wherein each partial sum is a Kₛ-bit number, wherein a Kₛ-bit number is a product of a first number, having a binary expansion that has a length Kₛ, and a second number, wherein the second number is equal to 2 to the power of a third number that is a positive integer.

11. The method of claim 1, wherein the sequence of symbols has a length that is 2 to the power of an integer.

12. The method of claim 1, wherein selecting the symbol of the sequence of symbols comprises:
identifying an interval, between a first interval boundary and a second interval boundary of the interval boundaries of the partial sums, that includes an information integer; and
selecting the symbol based at least in part on the symbol being associated with the interval.

13. The method of claim 12, wherein the first interval boundary and the second interval boundary comprise Kₓ-bit numbers,
wherein a Kₓ-bit number is a product of a first number, having a binary expansion that has a length Kₓ, and a second number, and wherein the second number is equal to 2 to the power of a third number that is a positive integer.

14. A wireless communication device (WCD) for wireless communication, comprising:
one or more processors; and
memory coupled to the one or more processors, the memory storing instructions executable by the one or more processors to cause the WCD to:
encode a set of bits to a sequence of symbols, members of the sequence of symbols included in a set of symbols, the encoding using finite-precision energy-based arithmetic encoding and including iterative operations comprising:
identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions;
identifying interval boundaries based at least in part on partial sums of the one or more quantities; and
selecting a symbol of the sequence of symbols based at least in part on the interval boundaries and an information integer to be encoded, the information integer being based at least in part on an integer representation of the set of bits; and
transmit a communication that includes the sequence of symbols encoded with the finite-precision energy-based arithmetic encoding.

15. The WCD of claim 14, wherein the iterative operations further include, based at least in part on selecting the symbol of the sequence of symbols, one or more of:
updating a remaining amount of the maximum sequence energy,
updating the length of remaining symbols of the sequence,
updating the quantity of the candidate sequences, or
updating an information integer used to select the symbol of the sequence of symbols.

16. The WCD of claim 14, wherein the iterative operations comprise a number of iterations of the operations that is less than or equal to a length of the sequence of symbols.

17. The WCD of claim 14, wherein each quantity of the quantities of candidate sequences is associated with a respective energy of the set of symbols, and
wherein a number of quantities of candidate sequences is based at least in part on a number of symbols of the set of symbols.

18. The WCD of claim 14, wherein the instructions are further executable by the one or more processors to cause the WCD to:
transmit an indication of parameters for finite-precision energy-based arithmetic encoding, one of the parameters including a maximum sequence energy of a set of symbols of a sequence of amplitude symbols.

19. The WCD of claim 18, wherein the iterative operations encode the set of bits based at least in part on the parameters.

20-28. (canceled)

29. An apparatus for wireless communication, comprising:
means for encoding a set of bits to a sequence of symbols, members of the sequence of symbols included in a set of symbols, the encoding using finite-precision energy-based arithmetic encoding and including iterative operations comprising:
means for identifying one or more quantities of candidate sequences having a length of remaining symbols of the sequence after selecting a symbol of the sequence of symbols, having members included in the set of symbols, and satisfying a remaining amount of a maximum sequence energy after using the selected symbol, the one or more quantities having finite precisions;
means for identifying interval boundaries based at least in part on partial sums of the one or more quantities; and
means for selecting a symbol of the sequence of symbols based at least in part on the interval boundaries and an information integer to be encoded, the information integer being based at least in part on an integer representation of the set of bits; and
means for transmitting a communication that includes the sequence of symbols encoded with the finite-precision energy-based arithmetic encoding.

30. (canceled)
